(19) United States
(12) Patent Application Publication
(10) Pub. No.: US 2016/0360397 A1
(43) Pub. Date: Dec. 8, 2016

(54) COLOR CODING FOR DATA CONFIRMATION SIGNALS

(71) Applicant: QUALCOMM Incorporated, San Diego, CA (US)

(72) Inventors: George CHERIAN, San Diego, CA (US); Gwendolyn Denise BARRIAC, Encinitas, CA (US); Simone MERLIN, San Diego, CA (US); Alfred ASTERJADHI, San Diego, CA (US); Gang DING, San Diego, CA (US); Yan ZHOU, San Diego, CA (US); Qingjiang TIAN, San Diego, CA (US)

(21) Appl. No.: 15/166,155

(22) Filed: May 26, 2016

Related U.S. Application Data
(60) Provisional application No. 62/170,070, filed on Jun. 2, 2015.

(51) Int. Cl. H04W 8/02; H04W 24/08; H04W 28/06; H04L 29/08; H04L 29/06

(52) U.S. Cl. CPC H04W 8/02; H04L 67/06; H04L 69/22; H04W 28/065; H04W 24/08

(57) ABSTRACT

A method, an apparatus, and a computer-readable medium for wireless communication are provided. The apparatus is a first wireless device that may be configured to receive a data confirmation message from a second wireless device. The data confirmation message may indicate whether the second wireless device successfully received data transmitted to the second wireless device. The first wireless device may be configured to determine whether the second wireless device is associated with the first BSS or a second BSS different from the first BSS based on the received data confirmation message and on a MAC header of the received data confirmation message. The first wireless device may be configured to transmit in a time period to a third wireless device based on the determination of whether the second wireless device is associated with the first BSS or with the second BSS different from the first BSS.

### CROSS-REFERENCE TO RELATED APPLICATION(S)

This application claims the benefit of U.S. Provisional Application Ser. No. 62/170,070, entitled “COLOR CODING FOR DATA CONFIRMATION SIGNALS” and filed on Jun. 2, 2015, which is expressly incorporated by reference herein in its entirety.

### BACKGROUND

### Field

The present disclosure relates generally to communication systems, and more particularly, to color coding for data confirmation signals.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable medium, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides an apparatus for wireless communication. The apparatus is a first wireless device. The first wireless device may be configured to receive a data confirmation message from a second wireless device. The data confirmation message may indicate whether the second wireless device successfully received data transmitted to the second wireless device. The first wireless device may be configured to determine whether the second wireless device is associated with the first basic service set or a second basic service set different from the first basic service set based on the received data confirmation message and on a medium access control header of the received data confirmation message. The second basic service set may be an overlapping basic service set that is different from the first basic service set associated with the first wireless device. The first wireless device may be configured to transmit in a time period to a third wireless device based on the determination of whether the second wireless device is associated with the first BSS or with the second BSS different from the first BSS.

### BRIEF DESCRIPTION OF THE DRAWINGS

FIG. 1 shows an example wireless communication system in which aspects of the present disclosure may be employed.

FIG. 2 is an exemplary diagram of a wireless network utilizing data confirmation messages with color information.

FIG. 3 shows an example functional block diagram of a wireless device that may utilize data confirmation messages with color information within the wireless communication system of FIG. 1.

FIG. 4 is a flowchart of an example method of utilizing a data confirmation message with color information for wireless communication.

FIG. 5 is a functional block diagram of an example wireless communication device that may utilize color information in data confirmation messages.

FIG. 6 is an exemplary diagram of a data confirmation message.

FIG. 7 is a diagram illustrating an exemplary method for increasing reuse based on color information.

### DETAILED DESCRIPTION

Various aspects of the novel systems, apparatuses, computer-readable medium, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a WiFi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, the station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

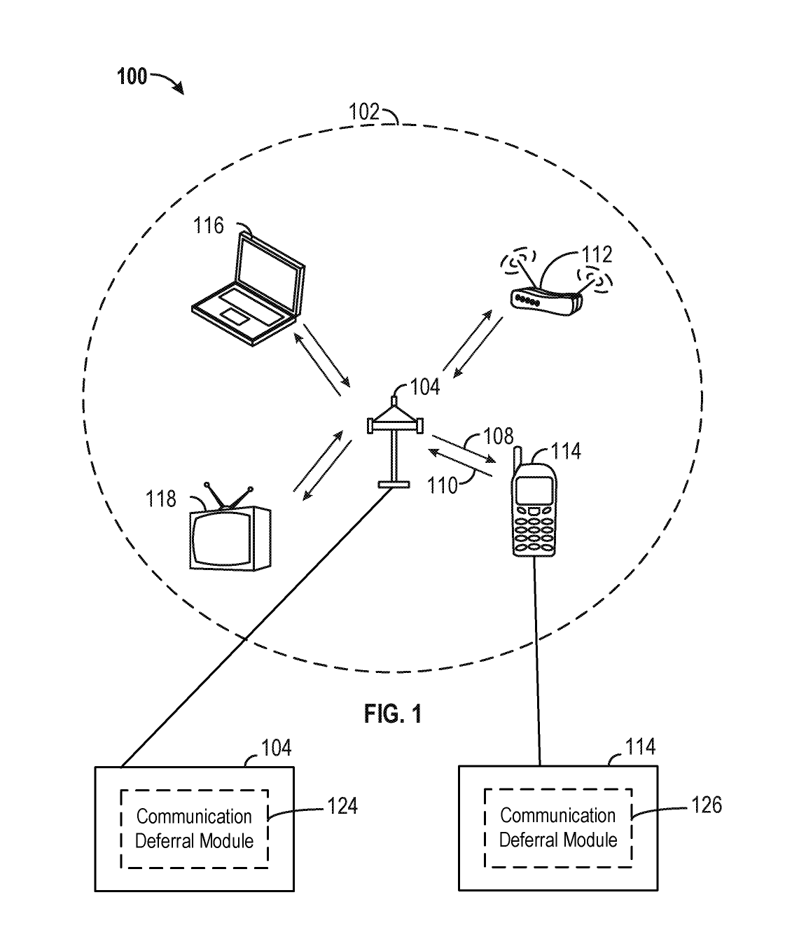

FIG. 1 shows an example wireless communication system 100 in which aspects of the present disclosure may be employed. The wireless communication system 100 may operate pursuant to a wireless standard, for example the 802.11 standard (or to future the 802.11 standards). The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 may include one or more components for performing various functions. For example, the AP 104 may include a communication deferral component 124 to perform procedures related to refraining from transmitting based on color information. In this example, the communication deferral component 124 may be configured to receive a data confirmation message from a second wireless device. The data confirmation message may indicate whether the second wireless device successfully received data transmitted to the second wireless device. The communication deferral component 124 may be configured to determine whether the received data confirmation message is received from an OBSS. The OBSS may be a first BSS different from a second BSS associated with the first wireless device. The communication deferral component 124 may be configured to determine whether to refrain from transmitting based on the determination of whether the received data confirmation message is received from the OBSS.

In another aspect, the STA 114 may include one or more components for performing various functions. For example, the STA 114 may include a communication deferral component 126. In this example, the communication deferral component 126 may be configured to receive a data confirmation message from a second wireless device. The data confirmation message may indicate whether the second wireless device successfully received data transmitted to the second wireless device. The communication deferral component 126 may be configured to determine whether the received data confirmation message is received from an OBSS. The OBSS may be a first BSS different from a second BSS associated with the first wireless device. The communication deferral component 126 may be configured to determine whether to refrain from transmitting based on the determination of whether the received data confirmation message is received from the OBSS.

To increase reuse in a wireless network, wireless devices within the wireless network may transmit on top of transmissions coming from an OBSS and refrain from transmitting on top of transmission coming from the same BSS (also known as in-BSS). To enable a wireless device to determine whether a transmission is from the same BSS as the wireless device or from an OBSS, transmitted packets may include a color code/information that identifies the BSS from which the packets originated. Color code/information may be a BSS identifier (BSSID), or a partial BSSID, or another identifier (e.g., a 6-bit identifier). When the wireless device receives a packet with color information, the wireless device may determine if the packet is associated with the same BSS as the wireless device or if the packet is associated with an OBSS. In some instances, certain messages in wireless networks such as a request to send (RTS) message, a clear to send (CTS) message, and a data message may include color information. However, data confirmation messages (e.g., ACK/NACK messages) may not include color information. As a result, wireless devices receiving data confirmation messages may defer even when the data confirmation messages originate from an OBSS. In some instances, data confirmation messages may be long (e.g., a block acknowledgment sent at a low modulation and coding scheme (MCS) or a multi-user acknowledgment). Without color information, data confirmation messages may cause unnecessary deferral (e.g., refraining from transmitting) to messages originating from an OBSS. As such, a need exists to add color information to data confirmation packets, such as ACK and NACK packets, to enable wireless devices to determine from which BSS a packet originates and to determine whether to defer communications based on the BSS associated with the packet.

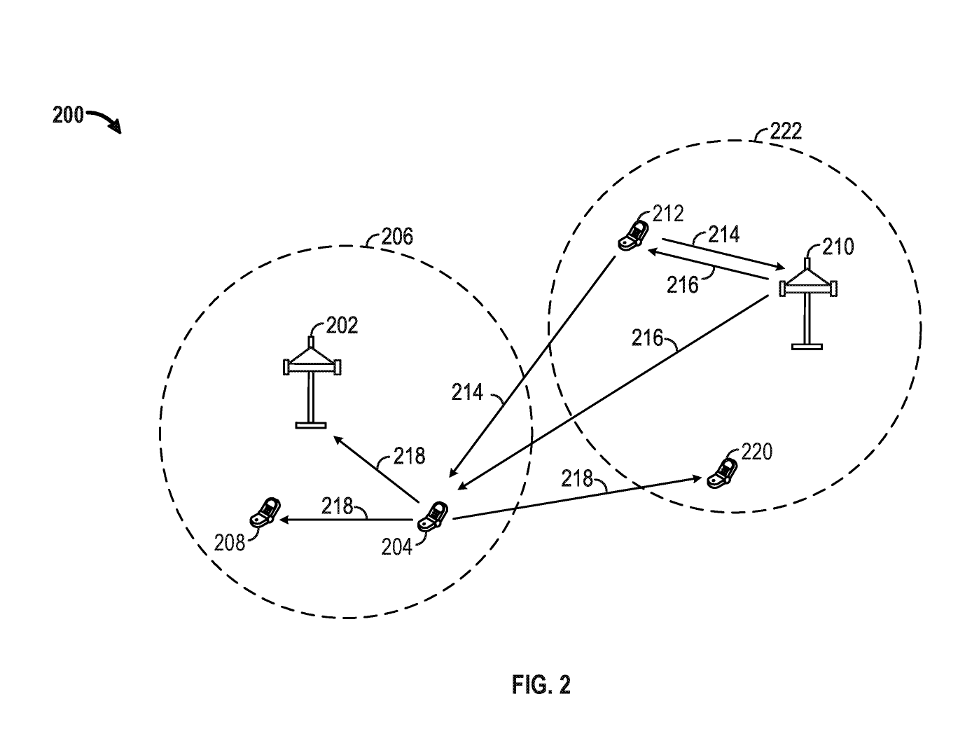

FIG. 2 is an exemplary diagram 200 of a wireless network utilizing data confirmation messages with color information. The diagram 200 illustrates a first AP 202 associated with a first STA 204 and a second STA 208. The first AP 202, the first STA 204, and the second STA 208 may be associated with a first BSS 206. FIG. 2 also illustrates a second AP 210 associated with a third STA 212 and a fourth STA 220. The second AP 210, the third STA 212, and the fourth STA 220 may be associated with a second BSS 222. In FIG. 2, the first STA 204 and the second STA 208 are in the same BSS as the first AP 202 because the first STA 204 and the second STA 208 may use the first AP 202 for communicating (e.g., the first AP 202 serves the first STA 204 and the second STA 208). The second BSS 222 may be considered an OBSS with respect to the first BSS 206 because messages transmitted from the second BSS 222 may be received by the wireless devices (e.g., the first AP 202 or the first STA 204) in the first BSS 206.

Referring to FIG. 2, the third STA 212 may be communicating with the second AP 210. For example, the third STA 212 may be transmitting data packets to the second AP 210 and vice versa. In response to receiving data packets from the second AP 210, the third STA 212 may transmit a first data confirmation message 214. The first data confirmation message 214 may be an acknowledgement (ACK) or a negative acknowledgment (NACK) depending on whether the third STA 212 successfully received data from the second AP 210. Because of the proximity between wireless devices in the first BSS 206 and wireless devices in the second BSS 222 (e.g., less than 20 feet), the first STA 204 may receive the first data confirmation message 214 transmitted by the third STA 212. Upon receiving the first data confirmation message 214, the first STA 204 may want to know whether the first STA 204 should defer communications (e.g., refrain from transmitting or transmit at a later time period) based on the first data confirmation message 214. To make such a determination, the first STA 204 may determine whether the first data confirmation message 214 is from the first BSS 206 or a different BSS (e.g., the second BSS 222) that is not associated with the first STA 204.

The first STA 204 may have various ways for determining from which BSS the first data confirmation message 214 originated depending on (i) a preamble and/or information in different fields in the first data confirmation message 214 and/or (ii) who is the transmitter of the first data confirmation message 214. In one configuration, the first data confirmation message 214 may include a preamble that has a BSSID or color information associated with the first data confirmation message 214. The BSSID or color information may identify from which BSS the first data confirmation message 214 originated. Upon receiving the first data confirmation message 214, the first STA 204 may determine whether the first data confirmation message 214 includes a preamble that indicates the BSSID from which the first data confirmation message 214 originated. If the preamble includes a BSSID, the first STA 204 may determine whether the BSSID is the same as the BSSID for the first BSS 206. If the BSSID is the same as the BSSID of the first BSS 206, then the first STA 204 may refrain from transmitting for at least the duration of the first data confirmation message 214 in order to reduce interference to another wireless device within the same BSS that is using the medium. The duration of the first data confirmation message 214 may be determined based on a value in a length field of the first data confirmation message 214. By contrast, if the BSSID is different from the BSSID of the first BSS 206, then the first STA 204 may transmit any data and/or control information during the duration of the first data confirmation message 214. The first STA 204 may not defer to data confirmation messages from an OBSS because the interference caused to an OBSS, due to transmissions from the first STA 204, may be minimal. Further, by not deferring communications for OBSS data confirmation messages, the first STA 204 increases medium reuse because the first STA 204 will have more opportunities to transmit data and/or control information.

In another configuration, the BSSID or color information may be provided in a medium access control (MAC) header rather than (or in addition to) the preamble. In one aspect, the first data confirmation message 214 may be a block data confirmation message (e.g., a block ACK) or a multi-user (MU) acknowledgment message (e.g., an MU ACK). A block data confirmation message may indicate whether one or more data packets were successfully received by a wireless device (e.g., the third STA 212). A multi-user acknowledgment message may indicate whether one or more wireless devices (e.g., the third STA 212 and the fourth STA 220) successfully received a data packet. A multi user acknowledgement may also be sent from an AP (e.g., the second AP 210), which acknowledges the reception of packets from multiple STAs (e.g., the third and fourth STAs 212, 220). Both a block data confirmation message and an MU data confirmation message may include a transmitter address field and a receiver address field. The transmitter address field may include an address of the transmitter (or sender) of the first data confirmation message 214. The receiver address field may include an address of the intended recipient of the first data confirmation message 214. Because the first data confirmation message 214 is transmitted by the third STA 212, the receiver address field may include the address of the second AP 210. By using the address of the second AP 210, the first STA 204 may determine that the first data confirmation message 214 originated from the second BSS 222, which is an OBSS. As a result, the first STA 204 may not refrain from transmitting any data (e.g., not defer communications), which increases medium reuse. By contrast, if the first data confirmation message 214 was in-BSS (e.g., originating from the first BSS 206), then the first STA 204 may refrain from transmitting so as not to cause interference within the first BSS 206. In this aspect, because the first data confirmation message 214 was transmitted by a STA, the transmitter address field may include the address associated with the third STA 212, but that address alone may not enable the first STA 204 to determine whether the first data confirmation message 214 is in-BSS or OBSS. As such, when the first data confirmation message 214 is transmitted by a STA, the receiver address field may provide an indication of whether the first data confirmation message 214 is received from an OBSS, but not the transmitter address field. However, as further discussed below, if an AP transmits a data confirmation message, then the transmitter address field may be used for determining whether the data confirmation message is received from an OBSS. As also discussed below, if the receiver address field includes a BSSID (e.g., in addition to a receiver address) associated with the data confirmation message, then the receiver address field may be used for determining whether the data confirmation message is received from an OBSS.

In another aspect, the first data confirmation message 214 may be single packet and single user data confirmation message (e.g., not a block data confirmation message and not a multi-user data confirmation message) and may include a receiver address field (e.g., in a MAC header) that includes color information. The receiver address field may include an address corresponding to the intended recipient of the first data confirmation message 214. In one instance, the receiver address field of the first data confirmation message 214 may include the address of the second AP 210. In another instance, one or more bits of the receiver address field of the first data confirmation message 214 may include the BSSID of the second BSS 222 (e.g., in addition to the address of the intended recipient). When the first data confirmation message 214 includes the BSSID, one or more bits in a frame control field of the first data confirmation message 214 may indicate that the receiver address field includes the BSSID. Alternatively, the third STA 212 and the second AP 210 may negotiate and determine that the receiver address field should include the BSSID. In either instance, the receiver address field of the first data confirmation message 214 may enable the first STA 204 to determine that the first data confirmation message 214 is associated with the second BSS 222. Based on the determination that the first data confirmation message 214 is associated with the second BSS 222 (which is an OBSS), the first STA 204 may not defer communications and may thus proceed with transmitting any messages buffered for transmission. By contrast, if the first data confirmation message 214 is associated with the first BSS 206 (e.g., a data confirmation message from the second STA 208 to the first STA 204), then the first STA 204 may refrain from transmitting for at least the duration of the first data confirmation message 214 in order to reduce interference to another wireless device within the same BSS that is using the medium.

In another aspect, the first data confirmation message 214 may be a single packet and single user data confirmation message (e.g., not a block data confirmation message and not a multi-user data confirmation message) and may include an additional transmitter address field (e.g., in a MAC header) that includes an address corresponding to the transmitter (or sender) of the first data confirmation message 214 (a transmitter address field may not be in 802.11 ACK messages). The transmitter address field may also include a BSSID subfield and thus include a BSSID (or a partial BSSID). If both the transmitter address and the receiver address field are in the first data confirmation message 214, then the wireless device receiving the first data confirmation message 214 may discern the BSS associated with the first data confirmation message 214. The first data confirmation message 214 may include one or more bits in a frame control field that indicates that the transmitter address field is included in the first data confirmation message 214 and/or the transmitter address field includes the BSSID. In FIG. 2, however, the transmitter of the first data confirmation message 214 is the third STA 212. If the transmitter address field only included the address of the third STA 212, then the transmitter address field may not enable the first STA 204 to determine whether the first data confirmation message 214 originated from an OBSS. However, if the transmitter address field also included a BSSID, then the transmitter address field would enable the first STA 204 to determine whether the first data confirmation message 214 originated from an OBSS. In an aspect, because the receiver address field of the first data confirmation message 214 already includes the address of the second AP 210, a BSSID may not be needed to determine whether the first data confirmation message 214 is in-BSS or OBSS. Nevertheless, including the BSSID in a transmitter address field provides an additional (or an alternative) way to determine whether a data confirmation message is OBSS or in-BSS.

In sum, when a data confirmation message is transmitted by a STA, a wireless device may determine whether the data confirmation message is in-BSS or OBSS based on a preamble, a receiver address field (that may indicate the address of an AP), and/or a transmitter address field (that may include color information).

Referring again to FIG. 2, as a result of the communications between the third STA 212 and the second AP 210, the second AP 210 may receive a data message from the third STA 212. In response, the second AP 210 may transmit a second data confirmation message 216 to the third STA 212. The second data confirmation message 216 may be an ACK or a NACK depending on whether the second AP 210 successfully received data from the third STA 212. Because of the proximity between wireless devices in the first BSS 206 and wireless devices in the second BSS 222 (e.g., less than 20 feet), the first STA 204 may receive the second data confirmation message 216. Upon receiving the second data confirmation message 216, the first STA 204 may determine whether the second data confirmation message 216 is from the first BSS 206 or a different BSS (e.g., the second BSS 222) that is not associated with the first STA 204.

The first STA 204 may have various ways for determining from which BSS the second data confirmation message 216 originated. In one configuration, the second data confirmation message 216 may include a preamble that indicates a BSSID or color information associated with the second data confirmation message 216. The first STA 204 may determine whether the second data confirmation message 216 includes a preamble that indicates the BSSID from which the second data confirmation message 216 originated. If the preamble includes a BSSID, the first STA 204 may determine whether the BSSID is the same as the BSSID for the first BSS 206. If the BSSID is the same as the BSSID of the first BSS 206, then the first STA 204 may refrain from transmitting for at least the duration of the second data confirmation message 216 in order to reduce interference to another wireless device within the same BSS that is using the medium. By contrast, if the BSSID is different from the BSSID of the first BSS 206, then the first STA 204 may transmit any data and/or control information during the duration of the second data confirmation message 216. The first STA 204 may not defer to data confirmation messages from an OBSS because the interference caused to an OBSS, due to transmissions from the first STA 204, may be minimal. Further, by not deferring communications for OBSS data confirmation messages, the first STA 204 increases medium reuse because the first STA 204 will have more opportunities to transmit data and/or control information.

In another configuration, the BSSID or color information may be provided in a MAC header rather than (or in addition to) the preamble. In one aspect, the second data confirmation message 216 may be a block data confirmation message (e.g., a block ACK). A block data confirmation message may include a transmitter address field and a receiver address field. The receiver address field may include an address of the intended recipient of the second data confirmation message 216, which may be the address of the third STA 212. However, the address of the third STA 212 may not enable the first STA 204 to determine whether the second data confirmation message 216 is received from an OBSS. The transmitter address field may be used to determine whether the second data confirmation message 216 is received from an OBSS. The transmitter address field may include an address of the transmitter (or sender) of the second data confirmation message 216 (e.g., the second AP 210). Because the second data confirmation message 216 is transmitted by the second AP 210, the transmitter address field may include the address of the second AP 210. Based on the address of the second AP 210, the first STA 204 may determine that the second data confirmation message 216 is received from an OBSS and thus communication deferral is not required.

In another aspect, the second data confirmation message 216 may be associated with a single packet and single user (e.g., not a block data confirmation message and not a multi-user data confirmation message) and may include a receiver address field (e.g., in a MAC header) that includes color information. The receiver address field may include an address corresponding to the intended recipient of the second data confirmation message 216, which, in this case, is the third STA 212. However, the address of the third STA 212 may not enable the first STA 204 to determine whether the second data confirmation message 216 originated from an OBSS. As such, a BSSID may be inserted into the receiver address field (e.g., when the second data confirmation message 216 is transmitted by the second AP 210) such that the receiver address field may include an address and the BSSID. In an aspect, a number of bits within the receiver address field may be allocated for the BSSID or for color information. In an aspect, one or more bits in a frame control field of the second data confirmation message 216 may be used to indicate that the second data confirmation message 216 has a BSSID or color information in the receiver address field. In another aspect, the second AP 210 and the third STA 212 (and any other STAs associated with the second AP 210) may negotiate before sending any data confirmation messages and agree to include BSSID in the receiver address field. By using the BSSID/color information included in the second data confirmation message 216, the first STA 204 may determine that the second data confirmation message 216 originated from the second BSS 222, which is an OBSS. As a result, the first STA 204 may not refrain from transmitting any data (e.g., not defer communications), which increases medium reuse. By contrast, if the second data confirmation message 216 was in-BSS (e.g., originating from the first BSS 206), then the first STA 204 may refrain from transmitting so as not to cause interference within the first BSS 206.

In another aspect, the second data confirmation message 216 may be associated with a single packet and a single user (e.g., not a block data confirmation message and not a multi-user data confirmation message) and may include a transmitter address field (e.g., in a MAC header) that includes an address corresponding to the transmitter (or sender) of the second data confirmation message 216. The transmitter address field may also include a BSSID subfield and thus include a BSSID (or color information or a partial BSSID). The second data confirmation message 216 may include one or more bits in a frame control field that indicates that the transmitter address field is included in the second data confirmation message 216 and/or the transmitter address field includes the BSSID. Because the transmitter address field of the second data confirmation message 216 is associated with the second AP 210, the transmitter address field may enable the first STA 204 to determine whether the second data confirmation message 216 originated from an OBSS. Moreover, if the transmitter address field also included a BSSID, then the BSSID would also enable the first STA 204 to determine whether the second data confirmation message 216 originated from an OBSS.

In sum, when a data confirmation message is transmitted by an AP, a wireless device may determine whether the data confirmation message is in-BSS or OBSS based on a preamble, a receiver address field (that may include color information), and/or a transmitter address field (that may include an address of the AP).

Referring again to FIG. 2, the first AP 202 and the first STA 204 may be communicating. The first STA 204 may receive a data message from the first AP 202. The first STA 204 may transmit a third data confirmation message 218 to the first AP 202 indicating whether the data message was successfully received by the first STA 204. The third data confirmation message 218 may be received by the second STA 208 and the fourth STA 220. The second STA 208 may be in the same BSS (e.g., the first BSS 206) as the first STA 204, but the fourth STA 220 may be in a different BSS (e.g., the second BSS 222). In an aspect, the third data confirmation message 218 may enable the second STA 208 and the fourth STA 220 to determine whether to refrain from transmitting while the third data confirmation message 218 is being transmitted. In an aspect, the third data confirmation message 218 may be a block ACK/NACK or MU ACK/NACK (a data confirmation message may be multi-user if an AP also sent data messages to other STAs in the BSS). In another aspect, the third data confirmation message 218 may include BSSID or color information in a receiver address field. In this aspect, the third data confirmation message 218 may include one or more bits in a frame control field that indicates whether a BSSID is included in the receiver address field. Alternatively, whether a BSSID or color information is included in a receiver address field may be pre-negotiated between the first STA 204 and the first AP 202. In yet another aspect, the third data confirmation message 218 may include a transmitter address field and/or a BSSID field. In this aspect, one or more bits in the frame control field may indicate that the third data confirmation message 218 includes a transmitter address field and/or a BSSID field.

Although the aforementioned functions are discussed from a point of view of the first STA 204, the first AP 202 may also utilize color information in data confirmation messages to determine whether to refrain from transmitting. For example, the first AP 202 may receive a data confirmation message (e.g., the first data confirmation message 214 or the second data confirmation message 216). The first AP 202 may determine whether the received data confirmation message is received from an OBSS. The first AP 202 may determine whether to refrain from transmitting based on the determination of whether the received data confirmation message is received from the OBSS. In other words, the aforementioned functions are not limited to a STA and may be performed by either a STA or an AP. Additionally, the data confirmation messages need not be associated with communications between an AP and a STA. A wireless device may defer communications based on data confirmation messages transmitted in device-to-device communications (e.g., the first STA 204 transmits an ACK message to the second STA 208, and the ACK message is received by the fourth STA 220).

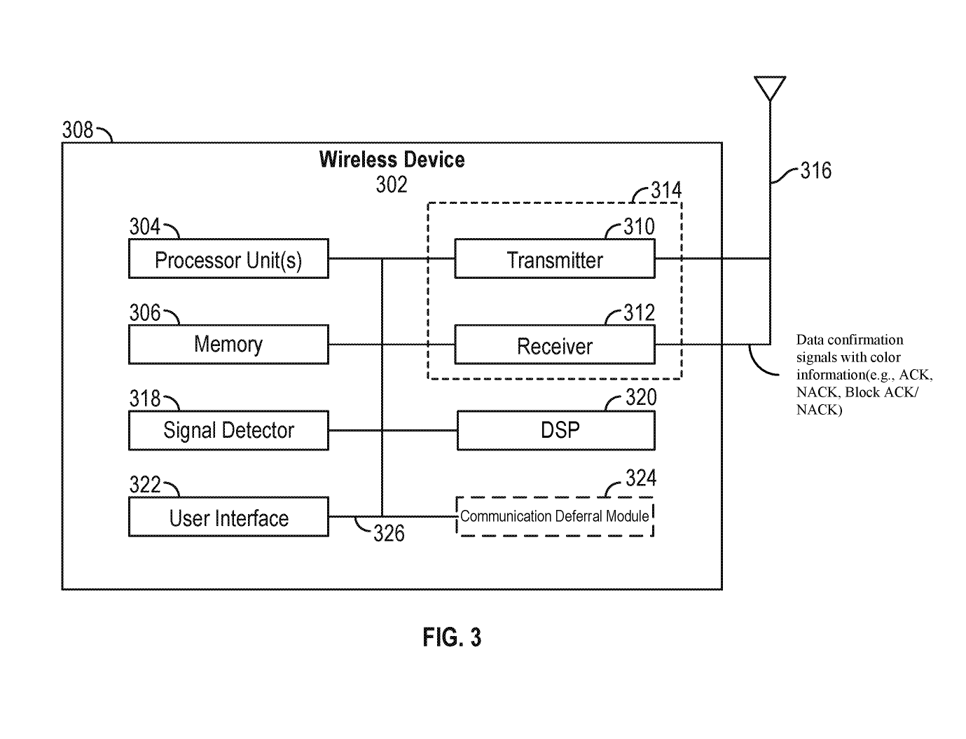

FIG. 3 shows an example functional block diagram of a wireless device 302 that may utilize data confirmation messages with color information within the wireless communication system 100 of FIG. 1. The wireless device 302 is an example of a device that may be configured to implement the various methods described herein. For example, the wireless device 302 may comprise one of the STAs 112, 114, 116, 118, 204, 208, 212, 214 or one of the APs 104, 202, 210.

The wireless device 302 may include a processor 304 which controls operation of the wireless device 302. The processor 304 may also be referred to as a central processing unit (CPU). Memory 306, which may include both read-only memory (ROM) and random access memory (RAM), may provide instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable (by the processor 304, for example) to implement the methods described herein.

The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 302 may also include a housing 308, and the wireless device 302 may include a transmitter 310 and/or a receiver 312 to allow transmission and reception of data between the wireless device 302 and a remote device. The transmitter 310 and the receiver 312 may be combined into a transceiver 314. An antenna 316 may be attached to the housing 308 and electrically coupled to the transceiver 314. The wireless device 302 may also include multiple transmitters, multiple receivers, multiple transceivers, and/or multiple antennas.

The wireless device 302 may also include a signal detector 318 that may be used to detect and quantify the level of signals received by the transceiver 314 or the receiver 312. The signal detector 318 may detect such signals as total energy, energy per subcarrier per symbol, power spectral density, and other signals. The wireless device 302 may also include a DSP 320 for use in processing signals. The DSP 320 may be configured to generate a packet for transmission. In some aspects, the packet may comprise a physical layer convergence procedure (PLCP) protocol data unit (PPDU).

The wireless device 302 may further comprise a user interface 322 in some aspects. The user interface 322 may comprise a keypad, a microphone, a speaker, and/or a display. The user interface 322 may include any element or component that conveys information to a user of the wireless device 302 and/or receives input from the user.

When the wireless device 302 is implemented as a STA (e.g., STA 114 or first STA 204) or an AP (e.g., AP 104 or first AP 202), the wireless device 302 may also comprise a communication deferral component 324. The communication deferral component 324 may be configured to receive a data confirmation message from a second wireless device. The data confirmation message may indicate whether the second wireless device successfully received data transmitted to the second wireless device. The communication deferral component 324 may be configured to determine whether the received data confirmation message is received from an OBSS. The OBSS may be a first BSS different from a second BSS associated with the wireless device 302. The communication deferral component 324 may be configured to determine whether to refrain from transmitting based on the determination of whether the received data confirmation message is received from the OBSS. In one configuration, the received data confirmation message may include a preamble, a receiver address field, or a transmitter address field. In this configuration, the communication deferral component 324 may be configured to determine whether the received data confirmation message is received from the OBSS by determining whether the preamble included in the received data confirmation message indicates a BSSID, and whether the indicated BSSID is an OBSS ID, determining whether the receiver address field included in the received data confirmation message indicates that the received data confirmation message is received from the OBSS, or determining whether the transmitter address field included in the received data confirmation message indicates that the received data confirmation message is received from the OBSS. In an aspect, the received data confirmation message may be received from an access point. In this aspect, the receiver address field may include the BSSID, and the determination of whether the received data confirmation message is received from the OBSS may be based on the BSSID in the receiver address field. In this aspect, the received data confirmation message may include an indicator in a frame control field indicating whether the receiver address field includes the BSSID. In this aspect, the receiver address field may include the BSSID based on a negotiation between the wireless device 302 and the access point in which the wireless device 032 and the access point agree to include the BSSID information in a receiver address field when the access point transmits the data confirmation message. In another configuration, the transmitter address field may include the BSSID. In this configuration, an indicator in a frame control field of the received data confirmation message may indicate that the received data confirmation message includes the transmitter address field. In this configuration, the determination of whether the received data confirmation message is received from the OBSS may be based on the BSSID in the transmitter address field. In another configuration, the received data confirmation message may be one of a block data confirmation message or a multi-user data confirmation message. In another configuration, the communication deferral component 324 may be configured to determine whether to refrain from transmitting by transmitting if the received data confirmation message is received from the OBSS and by refraining from transmitting if the received data confirmation message is not received from the OBSS. The non-deferral to the OBSS transmission may further be subject to additional constraints. In another configuration, the communication deferral component 324 may be configured to receiving a data message from another wireless device. In this configuration, the communication deferral component 324 may be configured to transmit a second data confirmation message to the another wireless devices based on whether the data message was successfully received by the wireless device 302. The second data confirmation message may enable at least one other wireless device to determine whether to refrain from transmitting. In an aspect, the second data confirmation message may include a second preamble, a second receiver address field, or a second transmitter address field. In this aspect, at least one of the second preamble, the second receiver address field, or the second transmitter address field may indicate whether the second data confirmation message is being transmitted from a different BSS than a BSS associated with the at least one other wireless device.

The various components of the wireless device 302 may be coupled together by a bus system 326. The bus system 326 may include a data bus, for example, as well as a power bus, a control signal bus, and a status signal bus in addition to the data 030284.11602 bus. Components of the wireless device 302 may be coupled together or accept or provide inputs to each other using some other mechanism.

Although a number of separate components are illustrated in FIG. 3, one or more of the components may be combined or commonly implemented. For example, the processor 304 may be used to implement not only the functionality described above with respect to the processor 304, but also to implement the functionality described above with respect to the signal detector 318, the DSP 320, the user interface 322, and/or the communication deferral component 324. Further, each of the components illustrated in FIG. 3 may be implemented using a plurality of separate elements.

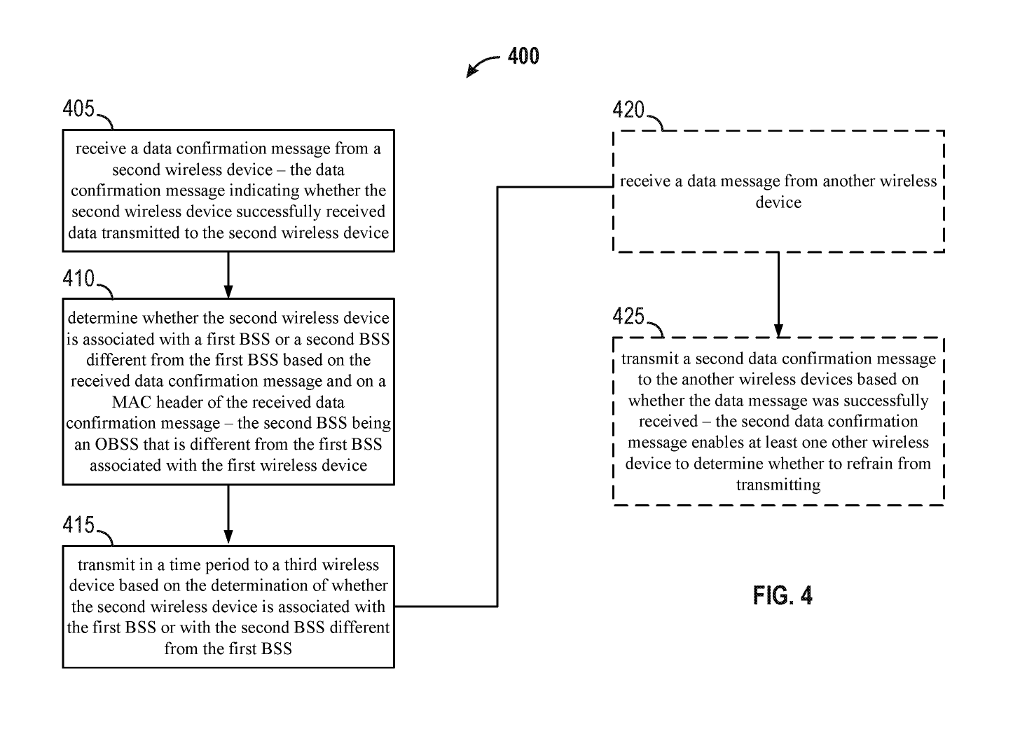

FIG. 4 is a flowchart of an example method 400 of utilizing a data confirmation message with color information for wireless communication. The method 400 may be performed using an apparatus (e.g., the STA 114, the AP 104, the first STA 204, the first AP 202, or the wireless device 302, for example). Although the method 400 is described below with respect to the elements of wireless device 302 of FIG. 3, other components may be used to implement one or more of the steps described herein.

At block 405, the apparatus, which is associated with a first BSS, may receive a data confirmation message from a second wireless device. The data confirmation message may indicate whether the second wireless device successfully received data transmitted to the second wireless device. In one example, referring to FIG. 2, the first STA 204 may receive the first data confirmation message 214 from the third STA 212. The first data confirmation message 214 may indicate whether the third STA 212 successfully received data transmitted to the third STA 212. In another example, referring to FIG. 2, the first STA 204 may receive the second data confirmation message 216 from the second AP 210. The second data confirmation message 216 may indicate whether the second AP 210 successfully received data transmitted to the second AP 210. In an aspect, the first data confirmation message 214 and/or the second data confirmation message 216 may each include a preamble, a receiver address field, and/or a transmitter address field.

At block 410, the apparatus may determine whether the second wireless device is associated with the first BSS or a second BSS different from the first BSS based 030284.11602 on the received data confirmation message and on a MAC header of the received data confirmation message. The second BSS may be an OBSS that is different from the first BSS associated with the apparatus. The apparatus may determine whether the received data confirmation message is received from the OBSS based on at least of determining whether the preamble included in the received data confirmation message indicates a BSSID, determining whether the receiver address field included in the received confirmation message indicates that the received data confirmation message is received from the OBSS, or determining whether the transmitter address field included in the received data confirmation message indicates that the received data confirmation message is received from the OBSS. In an aspect, the received data confirmation message may be received from an access point, and the receiver address field may include the BSSID. In this aspect, the determination of whether the received data confirmation message is received from the OBSS may be based on the BSSID in the receiver address field. Also in this aspect, the received data confirmation message may include an indicator in a frame control field indicating whether the receiver address field includes the BSSID or the BSSID included in the receiver address field may be based on a negotiation between the second wireless device and the access point. In another aspect, the transmitter address field may include the BSSID, and an indicator in a frame control field of the received data confirmation message may indicate that the received data confirmation message includes the transmitter address field, and the determination of whether the received data confirmation message is received from the OBSS is based on the BSSID in the transmitter address field. In another aspect, the received data confirmation message is one of a block data confirmation message (e.g., a block ACK) or a MU data confirmation message (e.g., an MU ACK). In this aspect, both the receiver address and the transmitter address are present, allowing a listener to discern from which BSS the message is received.

In one example, referring to FIG. 2, the first STA 204 may determine whether the first data confirmation message 214 is received from the second BSS 222. The second BSS 222 may be a different BSS than the first BSS 206 associated with the first STA 204. The first STA 204 may determine whether the first data confirmation message 214 is received from the second BSS 222 by determining whether a preamble included in the first data confirmation message 214 indicates a BSSID. The first STA 204 may determine whether the first data confirmation message 214 is received from the second BSS 222 by determining whether the receiver address field included in the first data confirmation message 214 indicates that the first data confirmation message 214 is received from the OBSS. The first STA 204 may determine whether the first data confirmation message 214 is received from the second BSS 222 by determining whether the transmitter address field included in the first data confirmation message 214 indicates that the received data confirmation message is received from the OBSS. In another aspect, the transmitter address field of the second data confirmation message 216 may include the BSSID, and an indicator in a frame control field of the first data confirmation message 214 may indicate that the first data confirmation message 214 includes the transmitter address field, and the determination of whether the first data confirmation message 214 is received from the second BSS 222 is based on the BSSID in the transmitter address field.

In another example, referring to FIG. 2, the first STA 204 may determine whether the second data confirmation message 216 is received from the second BSS 222. The second BSS 222 may be a different BSS than the first BSS 206 associated with the first STA 204. The first STA 204 may determine whether the second data confirmation message 216 is received from the second BSS 222 by determining whether a preamble included in the second data confirmation message 216 indicates a BSSID. The first STA 204 may determine whether the second data confirmation message 216 is received from the second BSS 222 by determining whether the receiver address field included in the second data confirmation message 216 indicates that the second data confirmation message 216 is received from the OBSS. In an aspect, the second data confirmation message 216 may be received from the second AP 210, and the receiver address field may include the BSSID. In this aspect, the determination of whether the second data confirmation message 216 is received from the OBSS may be based on the BSSID in the receiver address field. Also in this aspect, the second data confirmation message 216 may include an indicator in a frame control field indicating whether the receiver address field includes the BSSID or the receiver address field may include the BSSID based on a negotiation between the third STA 212 and the second AP 210. In another aspect, the first STA 204 may determine whether the second data confirmation message 216 is received from the second BSS 222 by determining whether the transmitter address field included in the second data confirmation message 216 indicates that the received data confirmation message is received from the OBSS (e.g., the transmitter address field may include the address of the second AP 210).

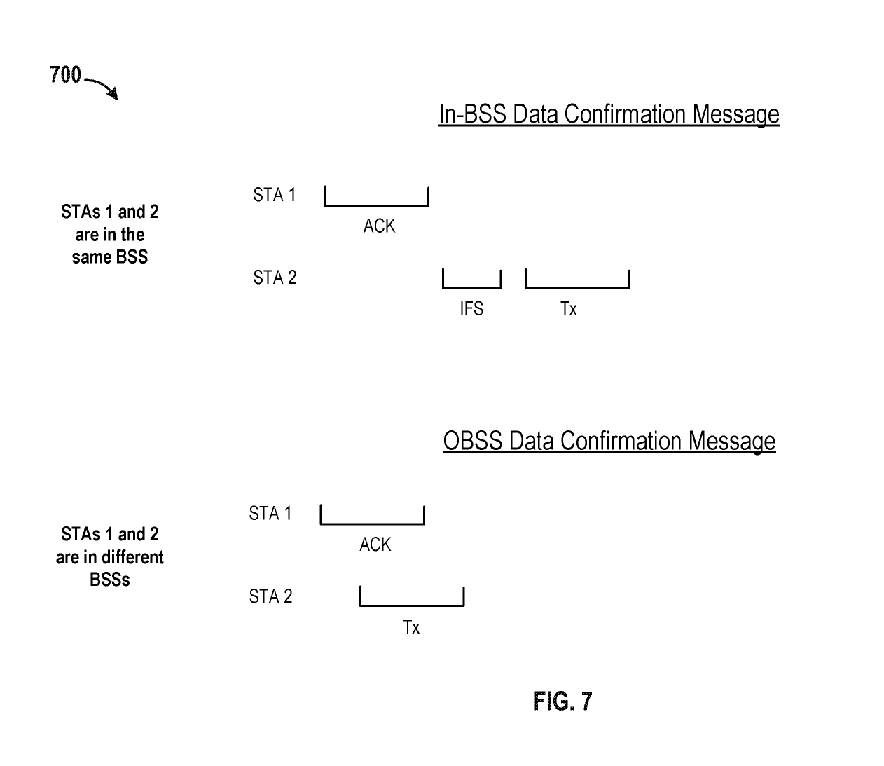

At block 415, the apparatus may transmit in a time period to a third wireless device based on the determination of whether the second wireless device is associated with the first BSS or with the second BSS different from the first BSS. For example, referring to FIG. 2, the first STA 204 may transmit to a device in the same BSS (e.g., the second STA 208 or the first AP 202) if the first data confirmation message 214 is received from the second BSS 222. The first STA 204 may transmit during a time period when the first data confirmation message 214 is being transmitted. However, if the first data confirmation message 214 is received from a device in the first BSS 206, then the first STA 204 may transmit in a time period after the first data confirmation message 214 is transmitted. This process may be further shown in FIG. 7.

At block 420, the apparatus may receive a data message from another wireless device. For example, referring to FIG. 2, the first STA 204 may receive a data message from the first AP 202.

At block 425, the apparatus may transmit a second data confirmation message to the another wireless devices based on whether the data message was successfully received. The second data confirmation message may enable at least one other wireless device to determine whether to refrain from transmitting. In an aspect, the second data confirmation message may include a second preamble, a second receiver address field, or a second transmitter address field. At least one of the second preamble, the second receiver address field, or the second transmitter address field may indicate whether the second data confirmation message is being transmitted from a different BSS than a BSS associated with the at least one other wireless device. For example, referring to FIG. 2, the first STA 204 may transmit the third data confirmation message 218 to the first AP 202 upon receiving a data message from the first AP 202. The third data confirmation message 218 may enable the second STA 208 and the fourth STA 220 (both of which may receive the third data confirmation message 218) to determine whether to refrain from transmitting. In this example, the second STA 208 may refrain from transmitting because the third data confirmation message 218 is in-BSS with respect to the second STA 208. The second STA 208 may determine that the third data confirmation message 218 is in-BSS based on a preamble, a receiver address field, and/or a BSSID in a transmitter address field of the third data confirmation message 218. However, the fourth STA 220 may not defer communications because the third data confirmation message 218 is received from an OBSS with respect to the fourth STA 220.

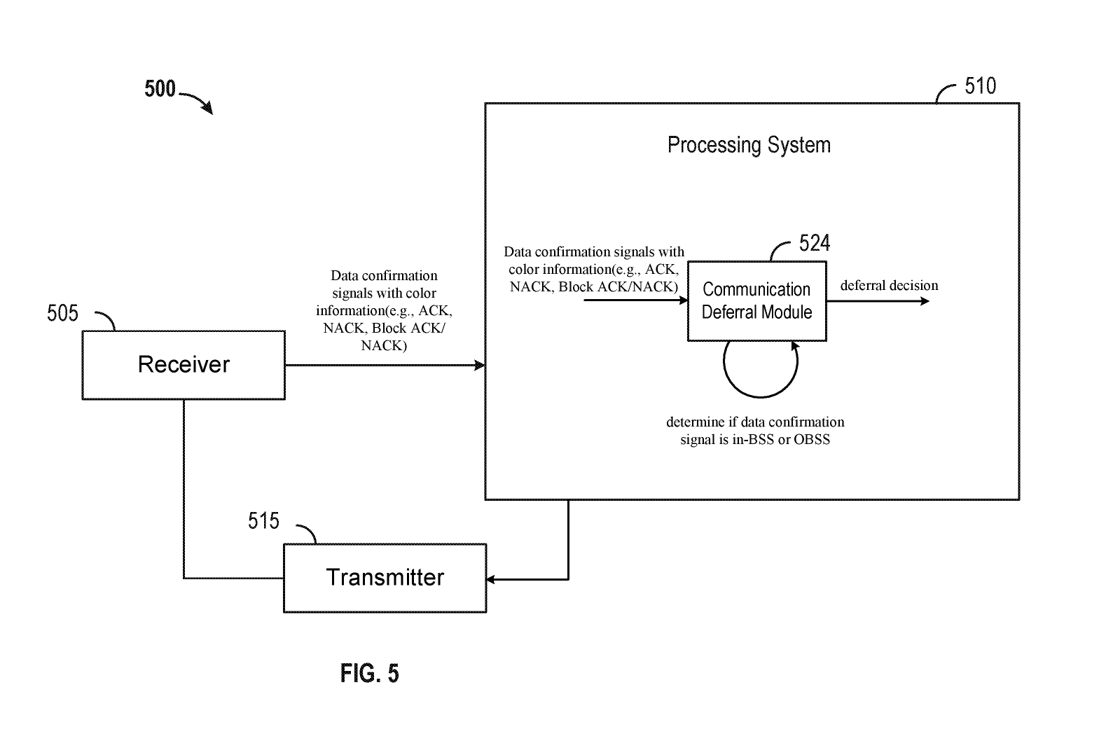

FIG. 5 is a functional block diagram of an example wireless communication device 500 that may utilize color information in data confirmation messages. The wireless communication device 500 may include a receiver 505, a processing system 510, and a transmitter 515. The processing system 510 may include a communication deferral component 524. The processing system 510, the communication deferral component 524, and/or the receiver 505 may be configured to receive a data confirmation message from a second wireless device. The data confirmation message may indicate whether the second wireless device successfully received data transmitted to the second wireless device. The processing system 510 and/or the communication deferral component 524 may be configured to determine whether the received data confirmation message is received from an OBSS. The OBSS may be a first BSS different from a second BSS associated with the wireless communication device 500. The processing system 510 and/or the communication deferral component 524 may be configured to determine whether to refrain from transmitting based on the determination of whether the received data confirmation message is received from the OBSS. In one configuration, the received data confirmation message may include a preamble, a receiver address field, or a transmitter address field. The determination of whether the received data confirmation message is received from the OBSS may include at least one of: determining whether the preamble included in the received data confirmation message indicates a BSSID, determining whether the receiver address field included in the received data confirmation message indicates that the received data confirmation message is received from the OBSS, or determining whether the transmitter address field included in the received data confirmation message indicates that the received data confirmation message is received from the OBSS. In another configuration, the received data confirmation message may be received from an access point, and the receiver address field may include the BSSID. In this configuration, the determination of whether the received data confirmation message is received from the OBSS may be based on the BSSID in the receiver address field. In this configuration, the received data confirmation message may include an indicator in a frame control field indicating whether the receiver address field includes the BSSID. In an aspect, the receiver address field may include the BSSID based on a negotiation between the second wireless device and the access point. In another configuration, the transmitter address field may include the BSSID. In this configuration, an indicator in a frame control field of the received data confirmation message may indicate that the received data confirmation message includes the transmitter address field. In this configuration, the determination of whether the received data confirmation message is received from the OBSS may be based on the BSSID in the transmitter address field. In one configuration, the received data confirmation message may be one of a block data confirmation message or a multi-user data confirmation message. In another configuration, the determination of whether to refrain from transmitting may include transmitting if the received data confirmation message is received from the OBSS and refraining from transmitting if the received data confirmation message is not received from the OBSS. In another configuration, the processing system 510, the communication deferral component 524, and/or the receiver 505 may be configured to receive a data message from another wireless device. In this configuration, the processing system 510, the communication deferral component 524, and/or the transmitter 515 may be configured to transmit a second data confirmation message to the another wireless devices based on whether the data message was successfully received. The second data confirmation message may enable at least one other wireless device to determine whether to refrain from transmitting. In an aspect, the second data confirmation message may include a second preamble, a second receiver address field, or a second transmitter address field. At least one of the second preamble, the second receiver address field, or the second transmitter address field may indicate whether the second data confirmation message is being transmitted from a different BSS than a BSS associated with the at least one other wireless device.

The receiver 505, the processing system 510, the communication deferral component 524, and/or the transmitter 515 may be configured to perform one or more functions discussed above with respect to blocks 405, 410, 415, 420, and 425 of FIG. 4. The receiver 505 may correspond to the receiver 312. The processing system 510 may correspond to the processor 304. The transmitter 515 may correspond to the transmitter 310. The communication deferral component 524 may correspond to the communication deferral component 124, the communication deferral component 126, and/or the communication deferral component 324.

The wireless communication device 500 may include means for receiving a data confirmation message from a second wireless device. The data confirmation message may indicate whether the second wireless device successfully received data transmitted to the second wireless device. The wireless communication device 500 may include means for determining whether the second wireless device is associated with the first BSS or a second BSS different from the first BSS based on the received data confirmation message and on a MAC header of the received data confirmation message. The second BSS may be an OBSS that is different from the first BSS associated with the first wireless device. The wireless communication device 500 may include means for transmitting in a time period to a third wireless device based on the determination of whether the second wireless device is associated with the first BSS or with the second BSS different from the first BSS. In an aspect, the time period may be during a transmission of the data confirmation message when the second wireless device is associated with the second BSS, and the time period may be after the transmission of the data confirmation message when the second wireless device is associated with the first BSS. In another aspect, the MAC header may include a receiver address field or a transmitter address field. In this aspect, the means for determining whether the second wireless device is associated with the first BSS or the second BSS may be configured to perform at least one of determining whether the receiver address field included in the received data confirmation message indicates that the second wireless device is associated with the first BSS or the second BSS or determining whether the transmitter address field included in the received data confirmation message indicates that the second wireless device is associated with the first BSS or the second BSS. In another aspect, the received data confirmation message may be received from an access point. The access point may be the second wireless device, and the receiver address field may include a BSSID. In this aspect, the determination of whether the second wireless device is associated with the first BSS or the second BSS may be based on the BSSID in the receiver address field. In another aspect, the received data confirmation message may include an indicator in a frame control field indicating whether the receiver address field includes the BSSID. In another aspect, the receiver address field may include the BSSID based on a negotiation between the second wireless device and another wireless device. In another aspect, the transmitter address field may include a BSSID, and the determination of whether the second wireless device is associated with the first BSS or the second BSS may be based on the BSSID in the transmitter address field. In another configuration, the wireless communication device 500 may include means for receiving a data message from another wireless device and means for transmitting a second data confirmation message to the another wireless device based on whether the data message was successfully received. The second data confirmation message may include a BSSID in a second MAC header that enables at least one other wireless device to determine whether to refrain from transmitting. In another aspect, the second data confirmation message may include a second receiver address field and/or a second transmitter address field and at least one the second receiver address field or the second transmitter address field may indicate whether the second data confirmation message is being transmitted from a different BSS than a BSS associated with the at least one other wireless device.

For example, means for receiving a data confirmation message may include the processing system 510, the communication deferral component 524, and/or the receiver 505. Means for determining whether the second wireless device is associated with the first BSS or a second BSS may include the processing system 510 and/or the communication deferral component 524. Means for transmitting may include the transmitter 515, the processing system 510, and/or the communication deferral component 524. Means for receiving a data message may include the processing system 510, the communication deferral component 524, and/or the receiver 505. Means for transmitting a second data confirmation message may include the processing system 510, the communication deferral component 524, and/or the transmitter 515.

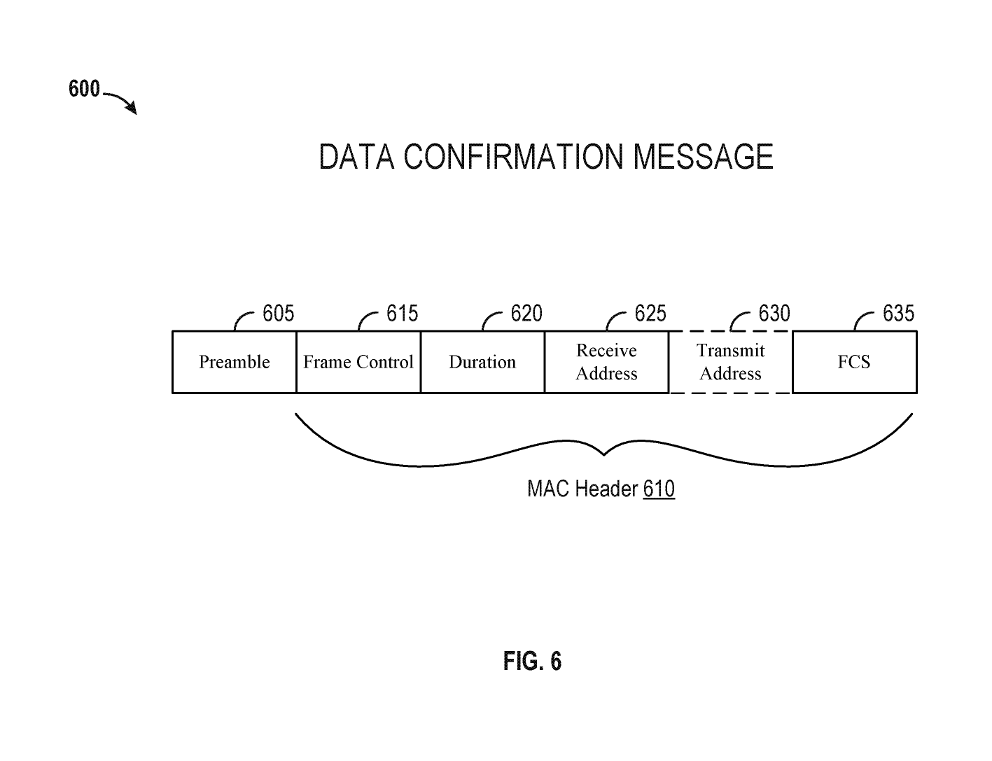

FIG. 6 is an exemplary diagram 600 of a data confirmation message. The data confirmation message (or frame) may include a preamble 605 and a MAC header 610. The MAC header may include a frame control field 615, a duration field 620, a receive address field 625, a transmit address field 630, and/or a frame control sequence (FCS) field 635. The preamble 605 may include information for performing channel estimation. The frame control field 615 may identify the function and/or the type of frame. The duration field 620 may indicate the duration of the frame (e.g., in microseconds) following the duration field 620. The receive address field 625 may indicate the intended recipient of the data confirmation message. The transmit address field 630 may indicate the transmitter of the data confirmation message. The FCS field 635 may indicate may include a 32-bit cyclic redundancy check (CRC).

As discussed in the foregoing disclosure, the BSSID or color information may be inserted into the various fields of the data confirmation message. In one example, the BSSID or color information may be inserted in the preamble 605. In another example, the BSSID or color information may be inserted in the receive address field 625 or the transmit address field 630.

FIG. 7 is a diagram 700 illustrating an exemplary method for increasing reuse based on color information. In one example, STA 1 and STA 2 may be in the same BSS. In this example, STA 1 may transmit an ACK frame that is received by STA 2. Based on BSSID or color information in the ACK frame, STA 2 may determine that STA 1 is in the same BSS as STA 2. Accordingly, STA 2 may set a network allocation vector (NAV) based on the duration indicated in the duration field of the ACK frame and wait to transmit until a time period after the ACK frame has been transmitted. In an aspect, the time period may be after the ACK frame has been transmitted and after an interframe space (IFS).

In another example, STA 1 and STA 2 may be in OBSSs. In this example, STA 1 may transmit an ACK frame. Based on BSSID or color information in the ACK frame, STA 2 may determine that STA 1 is in an OBSS with respect to STA 2; that is, STA 1 is in a different BSS than STA 2. Because STA 1 is unlikely to cause excessive interference to STA 2 when the STAs are in different BSSs, STA 2 may increase reuse by transmitting during a same time period in which STA 1 is transmitting the ACK frame.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, an FPGA, or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer-readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or 030284.11602 more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication by a first wireless device associated with a first basic service set (BSS), comprising:
receiving a data confirmation message from a second wireless device, the data confirmation message indicating whether the second wireless device successfully received data transmitted to the second wireless device;
determining whether the second wireless device is associated with the first BSS or a second BSS different from the first BSS based on the received data confirmation message and on a medium access control (MAC) header of the received data confirmation message, the second BSS being an overlapping BSS (OBSS) that is different from the first BSS associated with the first wireless device; and
transmitting in a time period to a third wireless device based on the determination of whether the second wireless device is associated with the first BSS or with the second BSS different from the first BSS.

2. The method of claim 1, wherein the time period is during a transmission of the data confirmation message when the second wireless device is associated with the second BSS, and the time period is after the transmission of the data confirmation message when the second wireless device is associated with the first BSS.

3. The method of claim 1, wherein the MAC header comprises a receiver address field or a transmitter address field, and wherein the determining whether the second wireless device is associated with the first BSS or the second BSS comprises at least one of:
determining whether the receiver address field included in the received data confirmation message indicates that the second wireless device is associated with the first BSS or the second BSS; or
determining whether the transmitter address field included in the received data confirmation message indicates that the second wireless device is associated with the first BSS or the second BSS.

4. The method of claim 3, wherein the received data confirmation message is received from an access point, the access point is the second wireless device, and the receiver address field includes a BSS identifier (BSSID), and wherein the determination of whether the second wireless device is associated with the first BSS or the second BSS is based on the BSSID in the receiver address field.

5. The method of claim 4, wherein the received data confirmation message includes an indicator in a frame control field indicating whether the receiver address field includes the BSSID.

6. The method of claim 4, wherein the receiver address field includes the BSSID based on a negotiation between the second wireless device and another wireless device.

7. The method of claim 3, wherein the transmitter address field includes a BSS identifier (BSSID), and wherein the determination of whether the second wireless device is associated with the first BSS or the second BSS is based on the BSSID in the transmitter address field.

8. The method of claim 1, further comprising:
receiving a data message from another wireless device; and
transmitting a second data confirmation message to the another wireless device based on whether the data message was successfully received, wherein the second data confirmation message includes a BSS identifier (BSSID) in a second MAC header that enables at least one other wireless device to determine whether to refrain from transmitting.

9. The method of claim 8, wherein the second data confirmation message comprises a second receiver address field or a second transmitter address field, and wherein at least one the second receiver address field or the second transmitter address field indicates whether the second data confirmation message is being transmitted from a different BSS than a BSS associated with the at least one other wireless device.

10. An apparatus for wireless communication, the apparatus being a first wireless device associated with a first basic service set (BSS), comprising:
a memory; and
at least one processor coupled to the memory and configured to:
receive a data confirmation message from a second wireless device, the data confirmation message indicating whether the second wireless device successfully received data transmitted to the second wireless device;
determine whether the second wireless device is associated with the first BSS or a second BSS different from the first BSS based on the received data confirmation message and on a medium access control (MAC) header of the received data confirmation message, the second BSS being an overlapping BSS (OBSS) that is different from the first BSS associated with the first wireless device; and
transmit in a time period to a third wireless device based on the determination of whether the second wireless device is associated with the first BSS or with the second BSS different from the first BSS.

11. The apparatus of claim 10, wherein the time period is during a transmission of the data confirmation message when the second wireless device is associated with the second BSS, and the time period is after the transmission of the data confirmation message when the second wireless device is associated with the first BSS.

12. The apparatus of claim 10, wherein the MAC header comprises a receiver address field or a transmitter address field, and wherein the at least one processor is configured to determine whether the second wireless device is associated with the first BSS or the second BSS by performing at least one of:
determining whether the receiver address field included in the received data confirmation message indicates that the second wireless device is associated with the first BSS or the second BSS; or
determining whether the transmitter address field included in the received data confirmation message indicates that the second wireless device is associated with the first BSS or the second BSS.

13. The apparatus of claim 12, wherein the received data confirmation message is received from an access point, the access point is the second wireless device, and the receiver address field includes a BSS identifier (BSSID), and wherein the determination of whether the second wireless device is associated with the first BSS or the second BSS is based on the BSSID in the receiver address field.

14. The apparatus of claim 13, wherein the received data confirmation message includes an indicator in a frame control field indicating whether the receiver address field includes the BSSID.

15. The apparatus of claim 13, wherein the receiver address field includes the BSSID based on a negotiation between the second wireless device and another wireless device.

16. The apparatus of claim 12, wherein the transmitter address field includes a BSS identifier (BSSID), and wherein the determination of whether the second wireless device is associated with the first BSS or the second BSS is based on the BSSID in the transmitter address field.

17. The apparatus of claim 10, wherein the at least one processor is further configured to:
receive a data message from another wireless device; and
transmit a second data confirmation message to the another wireless device based on whether the data message was successfully received, wherein the second data confirmation message includes a BSS identifier (BSSID) in a second MAC header that enables at least one other wireless device to determine whether to refrain from transmitting.

18. The apparatus of claim 17, wherein the second data confirmation message comprises a second receiver address field or a second transmitter address field, and wherein at least one the second receiver address field or the second transmitter address field indicates whether the second data confirmation message is being transmitted from a different BSS than a BSS associated with the at least one other wireless device.

19. An apparatus for wireless communication, the apparatus being a first wireless device associated with a first basic service set (BSS), comprising:
means for receiving a data confirmation message from a second wireless device, the data confirmation message indicating whether the second wireless device successfully received data transmitted to the second wireless device;
means for determining whether the second wireless device is associated with the first BSS or a second BSS different from the first BSS based on the received data confirmation message and on a medium access control (MAC) header of the received data confirmation message, the second BSS being an overlapping BSS (OBSS) that is different from the first BSS associated with the first wireless device; and
means for transmitting in a time period to a third wireless device based on the determination of whether the second wireless device is associated with the first BSS or with the second BSS different from the first BSS.

20. The apparatus of claim 19, wherein the time period is during a transmission of the data confirmation message when the second wireless device is associated with the second BSS, and the time period is after the transmission of the data confirmation message when the second wireless device is associated with the first BSS.

21. The apparatus of claim 19, wherein the MAC header comprises a receiver address field or a transmitter address field, and wherein the means for determining whether the second wireless device is associated with the first BSS or the second BSS is configured to perform at least one of:
determining whether the receiver address field included in the received data confirmation message indicates that the second wireless device is associated with the first BSS or the second BSS; or
determining whether the transmitter address field included in the received data confirmation message indicates that the second wireless device is associated with the first BSS or the second BSS.

22. The apparatus of claim 21, wherein the received data confirmation message is received from an access point, the access point is the second wireless device, and the receiver address field includes a BSS identifier (BSSID), and wherein the determination of whether the second wireless device is associated with the first BSS or the second BSS is based on the BSSID in the receiver address field.

23. The apparatus of claim 22, wherein the received data confirmation message includes an indicator in a frame control field indicating whether the receiver address field includes the BSSID.

24. The apparatus of claim 22, wherein the receiver address field includes the BSSID based on a negotiation between the second wireless device and another wireless device.

25. The apparatus of claim 21, wherein the transmitter address field includes a BSS identifier (BSSID), and wherein the determination of whether the second wireless device is associated with the first BSS or the second BSS is based on the BSSID in the transmitter address field.

26. The apparatus of claim 19, further comprising:
means for receiving a data message from another wireless device; and
means for transmitting a second data confirmation message to the another wireless device based on whether the data message was successfully received, wherein the second data confirmation message includes a BSS identifier (BSSID) in a second MAC header that enables at least one other wireless device to determine whether to refrain from transmitting.

27. The apparatus of claim 26, wherein the second data confirmation message comprises a second receiver address field or a second transmitter address field, and wherein at least one the second receiver address field or the second transmitter address field indicates whether the second data confirmation message is being transmitted from a different BSS than a BSS associated with the at least one other wireless device.

28. A computer-readable medium of a first wireless device associated with a first basic service set (BSS) storing computer executable code, comprising code to:
receiving a data confirmation message from a second wireless device, the data confirmation message indicating whether the second wireless device successfully received data transmitted to the second wireless device;
determining whether the second wireless device is associated with the first BSS or a second BSS different from the first BSS based on the received data confirmation message and on a medium access control (MAC) header of the received data confirmation message, the second BSS being an overlapping BSS (OBSS) that is different from the first BSS associated with the first wireless device; and
transmitting in a time period to a third wireless device based on the determination of whether the second wireless device is associated with the first BSS or with the second BSS different from the first BSS.

29. The computer-readable medium of claim 28, wherein the time period is during a transmission of the data confirmation message when the second wireless device is associated with the second BSS, and the time period is after the transmission of the data confirmation message when the second wireless device is associated with the first BSS.

30. The computer-readable medium of claim 28, wherein the MAC header comprises a receiver address field or a transmitter address field, and wherein the code to determine whether the second wireless device is associated with the first BSS or the second BSS comprises at least one of code to:
determine whether the receiver address field included in the received data confirmation message indicates that the second wireless device is associated with the first BSS or the second BSS; or
determine whether the transmitter address field included in the received data confirmation message indicates that the second wireless device is associated with the first BSS or the second BSS.
